(19) United States
(12) Patent Application Publication
(10) Pub. No.: US 2010/0058202 A1
(43) Pub. Date: Mar. 4, 2010

(54) METHOD SYSTEM AND PROGRAM PRODUCT FOR PROVIDING ENABLING AN INTERACTIVE AND SOCIAL SEARCH ENGINE

(76) Inventor: Mohamed Rostom, Calgary (CA)

Correspondence Address: BAY AREA INTELLECTUAL PROPERTY GROUP, LLC, PO BOX 210459, SAN FRANCISCO, CA, 94121-0459, US

(21) Appl. No.: 12/389,352

(22) Filed: Feb. 19, 2009

Related U.S. Application Data
(60) Provisional application No. 61/092,730, filed on Aug. 28, 2008.

(51) Int. Cl. G06F 3/048; G06F 17/30

(52) U.S. Cl. 715/758; 707/3; 715/786; 707/E17.108; 709/206

(57) ABSTRACT

A system for an interactive and social search engine includes a search component responding to a user's search request for generating a listing of search results including site addresses. A display component displays the listing along with a rating control for each site address in the listing. A rating component accepts inputs from the rating control to affect an order of the listing where a change in a rating of a site address dynamically controls the displaying of the listing and subsequent search requests. A browsing control component scrolls through and vies content of each site address in the listing. A chat component conducts organized communication sessions between users of the system. A communication component conducts communication between users of the system in real-time. A detection component detects concurrent users of the system requesting substantially similar searches and establishes communication between the concurrent users.

### CROSS-REFERENCE TO RELATED APPLICATIONS

The present Utility patent application claims priority benefit of the U.S. provisional application for patent serial number 61092730 filed on Aug. 28, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to search engines. More particularly, the invention relates to a method and system for an interactive and social search engine that connects people performing similar searches and enables these people to preview, rate, comment on and chat about external websites and news sources during their search.

### BACKGROUND OF THE INVENTION

Large networks such as the Internet comprise a vast amount of information, and navigating these networks to find specific information can be difficult for users. Much time and effort has been invested in creating approaches for aiding users in navigating these networks. For example, one known approach is to build an algorithm that uses a centralized system consisting of sophisticated servers to perform indexing and web crawling functions on the Internet. These servers browse the Internet in a methodical, automated manner using the governing algorithm. Another known approach involves the mapping of social networks. However, these approaches do not enable users to interact with the algorithm or mapping method.

With over 200 million searches per day on the Internet, Google, Yahoo, and MSN provide a standard approach that provides the status quo in search. However, basic searches on Google, MSN or Yahoo yield results without showing the previous “footsteps” of other users. These conventional approaches provide no guidance. An approach that aids users in searching by guiding them through other people's comments and experiences would be more helpful than these conventional approaches. A guided approach would take into consideration that every time a user searches a topic on the Internet, chances are that same topic has been searched thousands if not millions of times, and a pattern may be built from these previous searches to provide information from which others may learn.

In view of the foregoing, there is a need for improved techniques for aiding users in navigating large networks that are interactive and are enhanced by information learned from the searches and experiences of past users, as well as a system that enables users in a search based chat room to interact and exchange information in real time.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary screenshot from an interactive and social search engine, in accordance with an embodiment of the present invention;

FIG. 2 illustrates an exemplary screenshot from an interactive and social search engine, where multiple strings of from different categories are displayed at one time by row, in accordance with an embodiment of the present invention;

FIG. 3 illustrates an exemplary rating and scrolling toolbar for an interactive and social search engine in an Internet browser, in accordance with an embodiment of the present invention;

FIG. 4 is a flow chart illustrating an exemplary process for determining which chat rooms in a network are similar to a search topic of a user in an interactive and social search engine, in accordance with an embodiment of the present invention;

FIG. 5 is a flow chart illustrating an exemplary process for initiating a chat in an interactive and social search engine, in accordance with an embodiment of the present invention;

FIG. 6 is a flow chart illustrating an exemplary process for locating similar chat rooms for a similar chat room list in an interactive and social search engine, in accordance with an embodiment of the present invention;

FIG. 7 illustrates an exemplary screenshot of a live real time chat session, in accordance with an embodiment of the present invention;

FIG. 8 illustrates an exemplary screenshot of a notification system, in accordance with an embodiment of the present invention; and

FIG. 9 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and program product for an interactive and social search engine is presented.

In one embodiment, a system for an interactive and social search engine is presented. The system includes a search component responding to a user's search request for generating a listing of search results including site addresses. A display component displays the listing along with a rating control for each site address in the listing. A rating component accepts inputs from the rating control to affect an order of the listing where a change in a rating of a site address dynamically controls the displaying of the listing and subsequent search requests. Another embodiment further includes a browsing control component for scrolling through and viewing content of each site address in the listing. Yet another embodiment further includes a chat component for conducting organized communication sessions between users of the system where the sessions are organized by search topics. Still another embodiment further includes a communication component for communication between users of the system in real-time. Another embodiment further includes a detection component for detecting concurrent users of the system requesting substantially similar searches and for establishing communication between the concurrent users. In still another embodiment the display component displays the listing as a plurality of pages with site addresses in the listing grouped by type of content into a plurality of groupings where the plurality of pages can be scrolled for viewing and each of the plurality of groupings can be scrolled independently of the plurality of pages.

In another embodiment a system for an interactive and social search engine is presented. The system includes means for generating a listing of search results, means for displaying the listing along with a rating control and means for accepting inputs from the rating control to affect an order of the listing. Another embodiment further includes means for scrolling through and viewing content of sites in the listing. Yet another embodiment further includes means for conducting organized communication sessions between users of the system. Still another embodiment further includes means for communication between users of the system in real-time. Another embodiment further includes means for detecting concurrent users of the system requesting substantially similar searches and for establishing communication between the concurrent users.

In another embodiment a method for an interactive and social search engine is presented. The method includes the steps of receiving a listing of search results corresponding to a user's search request, displaying the listing along with a rating control for each site address in the listing and accepting inputs from the rating control to affect an order of the listing where a change in a rating of a site address dynamically controls the displaying of the listing and subsequent search requests. Another embodiment further includes the step of scrolling through and viewing content of each site address in the listing. Yet another embodiment further includes the step of conducting organized communication sessions between users of the system where the sessions are organized by search topics. Still another embodiment further includes the step of communication between users of the system in real-time. Another embodiment further includes the step of detecting concurrent users of the system requesting substantially similar searches and for establishing communication between the concurrent users. In another embodiment the step of displaying displays the listing as a plurality of pages with site addresses in the listing grouped by type of content into a plurality of groupings where the plurality of pages can be scrolled for viewing and each of the plurality of groupings can be scrolled independently of the plurality of pages.

In another embodiment a method for an interactive and social search engine is presented. The method includes steps for receiving a listing of search results corresponding to a user's search request, steps for displaying the listing along with a rating control and steps for accepting inputs from the rating control to affect an order of the listing. Another embodiment further includes steps for scrolling through and viewing content of sites in the listing. Yet another embodiment further includes steps for conducting organized communication sessions between users of the system. Still another embodiment further includes steps for communication between users of the system in real-time. Another embodiment further includes steps for detecting concurrent users of the system requesting substantially similar searches and for establishing communication between the concurrent users.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide a guided approach to searching a network that takes into consideration a pattern built from previous searches to provide information from which others may learn and add to. Preferred embodiments also enable ordinary users to help rate the sites returned by their searches based on technology that enables users to manually bump up or push down search listings, using a built in toolbar or constant frame embedded in all major web browsers. On the other hand, users and the comments posted by users help guide these search listings rather than servers alone. Preferred embodiments of the present invention provide a toolbar that enables users to perform various tasks such as, but not limited to, rating websites, scrolling through search result listings using special arrows thus eliminating the need to return to search results page, chatting with website visitors and administrative personnel, and leaving comments. Preferred embodiments also comprise a chat solution that connects people together at any moment while searching for similar topics. This approach adds a “human touch” to search where users can learn what other users have experienced when searching any given topic. Conventional search offerings do not enable users to participate in the process of determining the algorithm. In contrast, the “people powered” approach of preferred embodiments of the present invention enables every user to take part in indexing and rating the websites returned by the search engine.

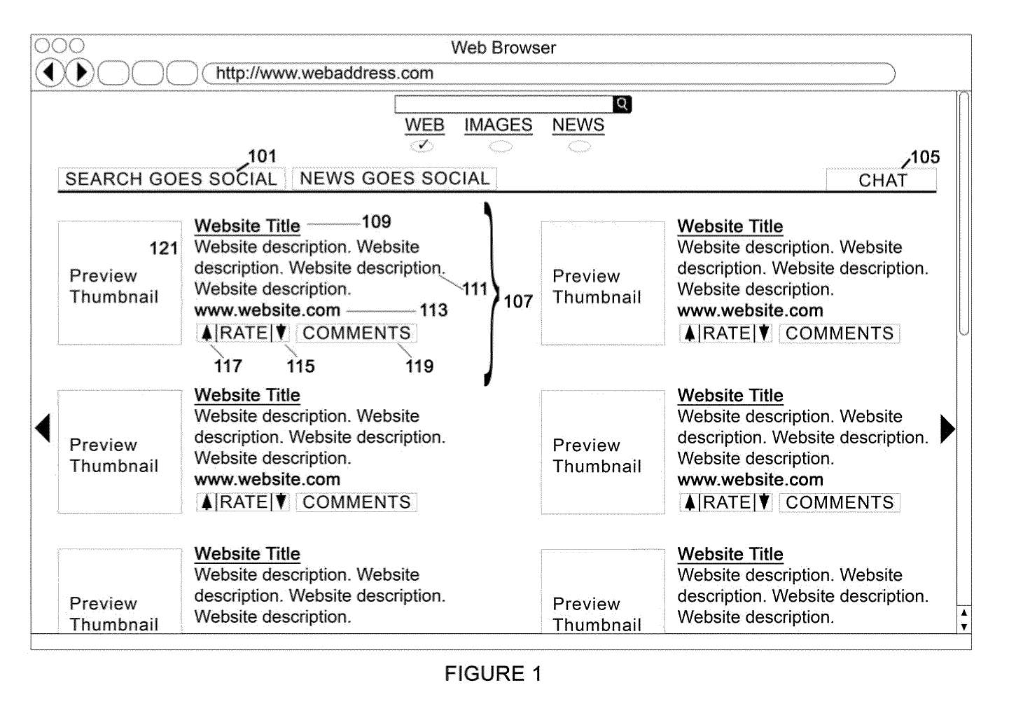

FIG. 1 illustrates an exemplary screenshot from an interactive and social search engine, in accordance with an embodiment of the present invention. In the present embodiment, a user may perform a search by selecting a social search tab 101. The user may also engage in a live chat with other users who are searching the same or similar topics at any existing moment in time after the system has detected the matching criteria by selecting a chat tab 105. The exemplary screen shown is of social search tab 101. On social search tab 101, website listings 107 that match the search criteria of the user are presented. Website listings 107 may be presented in various different orders for example, without limitation, alphabetical order, by rating, etc. Each website listing 107 comprises a website title 109, a website description 111, and a website address 113. A down arrow button 115 and an up arrow button 117 control a people powered algorithm that is continuously dynamic and enables users to affect how search results are displayed. This algorithm changes according to a special formula using a “human rating”. Down arrow button 115 decreases the human rating of a website while up arrow button 117 increases the human rating. A multiplicity of suitable means for inputting the ratings exist for alternate embodiments such as, but not limited to, different types of buttons, text boxes, sliding scales, etc. In the present embodiment, a comment button 119 for each website enables users of the search engine to relay their own experiences of any specific website whether positive or negative to help guide other users in the right direction. The rate buttons, down arrow button 115 and up arrow button 117, are different from comment button 119 in that the rate buttons enable users to manually adjust the search algorithm according to the special algorithm while comment button 119 enables users to make different comments. A thumbnail or preview button 121 enables users to view a snapshot image of the website without visiting the website. Those skilled in the art, in light of the present teachings, will readily recognize that alternate embodiments of the present invention may comprise a multiplicity of other functions and options on the search tab for example, without limitation, options to narrow the search or to perform an advanced search. Previous search platforms allow for only one search string of results to take place at a single time. Users may only see one type of results in a single browser window, such as, without limitation, of “Web”, “Images”, “News”, “Video”, etc. The present embodiment allows users to search multiple type of results as a part of a single search, displaying different types of results in separate rows or columns. The user may select in any combination to search, such as, but not limited to, “Web” with “Images” and/or “News” and/or “Video,” etc. The system is not limited to only those categories mentioned, and may include, but not limited to, “Music”, “Maps”, “Articles”, “Blogs”, and “Shopping”.

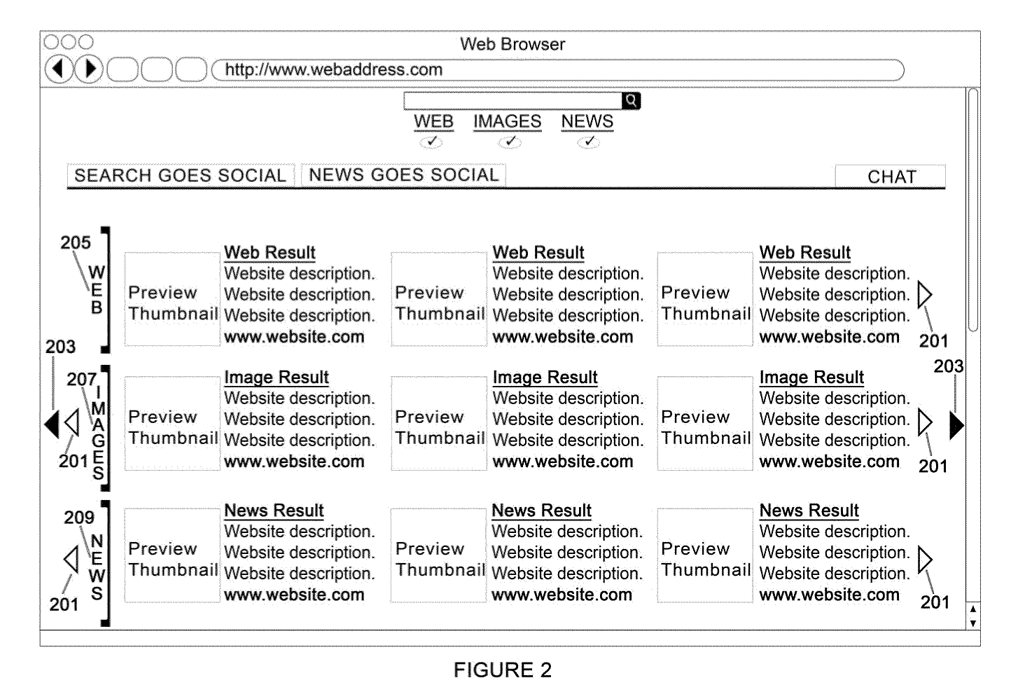

FIG. 2 illustrates an exemplary screenshot from an interactive and social search engine, where multiple strings of from different categories are displayed at one time by row, in accordance with an embodiment of the present invention. Minor scrolling arrows 201, allow for users to browse through results pertaining only to that row and category of search results. Major scrolling arrows 203, allow for users to browse through pages of search results, changing all the content of all the categories in a given search string. In this illustration, the categories are distributed by three rows, the first row 205 displaying “Web” results, the second row 207 displaying “Images” results, and the third row 209 displaying “News” results. In other embodiments the categories may be distributed in columns.

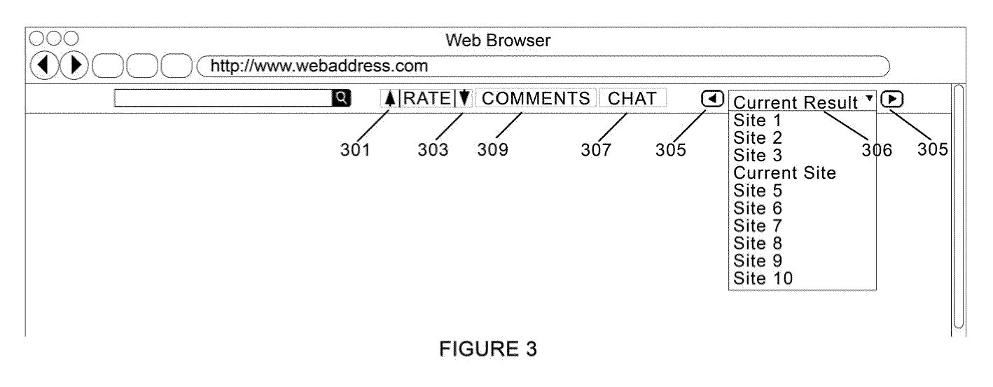

FIG. 3 illustrates an exemplary search toolbar or frame window for an interactive and social search engine in an Internet browser, in accordance with an embodiment of the present invention. In the present embodiment, the toolbar is a platform in the form of a plug-in that is compatible on any standard Internet browser. The toolbar provides novel features for rating websites, scrolling through search results listings, chatting with website visitors, administrative personnel or advertisers, and leaving comments. For rating sites, a user visiting any website can rate up and rate down any website using an up button 301 and a down button 303. The information is captured by servers and provides a democratic, socially powered algorithm system. This “human powered” approach has the ability to empower users and enable people to take part in the process of determining what sites are returned at the top of a set of search results and what sites do not deserve to be placed at the top of the list despite how much money the site owners spend on Search Engine Optimization (SEO) tools. This system also enables owners of small, random websites to input their websites into the search engine database to be introduced in a fair manner. The present embodiment also includes scrolling arrows 305 that enable users to scroll through the search results returned by the search engine. The conventional method of searching the Internet currently enables the user to enter a search term, click search and then view a page full of results and website listings. The user then clicks on a link and is directed to a new site or, in some cases, a new browser window opens a new page with the link. In the present embodiment, once a search term has been entered and the user browses to an external site from the result listings, scrolling arrows 305 enable a user to browse the results from the toolbar and click on any of the search result listings from the original search results page. The user is then directed to a new page where the user can again, click scrolling arrows 305, which enable the user to scroll ahead or back through the search result listings on the original search page after searching a topic, generally eliminating the need to continuously click the back button on the Internet browser to return to the main search engine. For example, without limitation, a user searches the term “law” in a search engine according to an embodiment of the present invention and receives ten different listings in the search results. He then clicks on a page and does not like what he sees. Instead of clicking the back button in the Internet browser to return to the main search page as is typically done, the user can click on a scroll arrow 305 to move ahead to the next listing or to go back to the previous listing. Furthermore, the toolbar in the present embodiment enables users to view all of the listings that are initially generated in a search results drop down menu 306 that provides the user with easy access to the results listed on the first search page without going back to that page. A chat button 307 enables users to engage with other users on the same site or to communicate directly with representatives on the visited website for example, without limitation, to inquire about a product or service. This “live” chat service although currently provided by third parties has not been part of the “search experience” previously. A comments button 309 enables users to comment on the results and view other users' experiences with specific websites.

In the present embodiment, the search engine integrates social network contribution by allowing users with accounts from third party social networks to login and share experiences via the toolbar. A user can view these contributions through the comments button and the updated order of all the search results from highest to lowest within the search engine. In the present embodiment, the social search is where users both perform the rating, and the user ratings are reflected when the results are refreshed.

The commercial success of a search engine is tied to basic advertising. The advertising method used by the present embodiment is more targeted and lasting than conventional advertising methods since it is personal real time search engine topic related and generated by an actual person within a chat session, rather than the conventional approach where advertising is placed on the top or right hand side of the screen. The present embodiment incorporates live advertising that enables advertisers to capture at any moment users who are looking for a topic related to the advertiser, creating a perfect live match. The present embodiment incorporates a “live” real time advertising model, without limitation, where logged in users skilled in a particular field of knowledge may enter a chat room and share their knowledge of this field with other users seeking this information through the current search engine. The present embodiment incorporates a rating system where the users providing the useful information to other users may be rated for their knowledge and compensated for this service. Alternate embodiments, such as forums and message boards provide a similar service, however, the present embodiment offers this service in “real time” and incorporates this feature within a search engine. Advertisers, who are experts in a given field or have specific services or products, after notification from our system, have access to the present embodiment by logging in to a backend server and are able to engage with users in a one to one environment, providing a unique real time advertising opportunity. Various embodiments of the present invention are configured to operate on various platforms, such as, but not limited to, mobile devices.

Preferred embodiments of the present invention provide a live search chat feature, which enables the system to match users who are searching the Internet and be automatically connected to other users searching the same or similar topics. Preferred embodiments detect key words and topics in a user's search and match these key words and topics in real time with other users who are basically performing the same search.

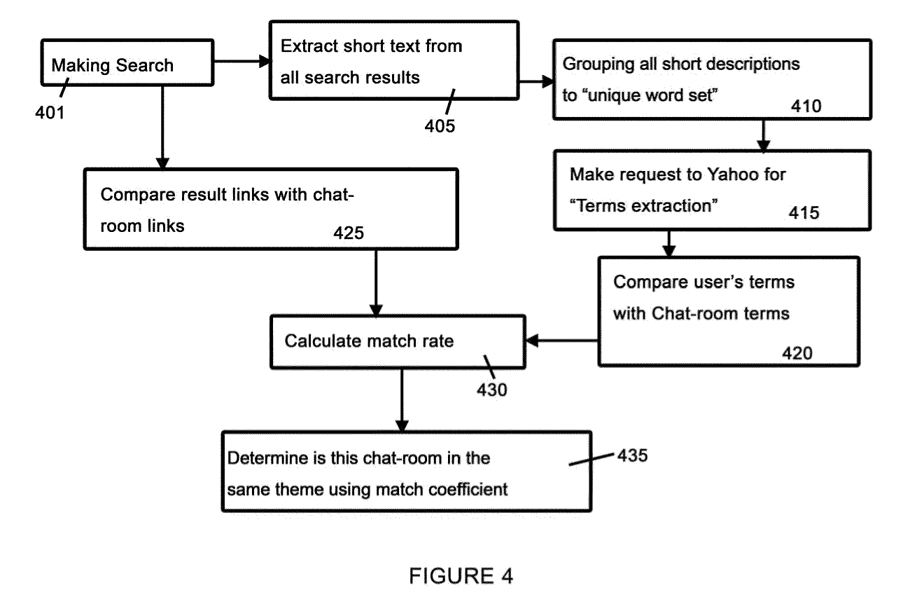

FIG. 4 is a flow chart illustrating an exemplary process for determining which chat rooms in a network are similar to a search topic of a user in an interactive and social search engine, in accordance with an embodiment of the present invention. In the present embodiment, users may enter a chat room to converse with friends or other users interested in the same or similar topics. In order to accomplish this, the system must compare the search topics of users to the search topics of other users and to the topics of chat rooms to find the same or similar theme of conversation for different users. The “similar” determination functionality in the present embodiment works by follow scheme.

First, in step 401a user performs a search that returns results comprising text descriptions. In step 405 the system extracts small page descriptions of all shown links for the last performed search. Then in step 410, these small descriptions are grouped to a unique word set. The system then makes a request to an indexed database to provide an “extract terms” functionality from any text from the unique word set in step 415. In step 420 the system compares the terms extracted from the user's search to terms within the chat rooms on the system. At the same time, in step 425, the system compares search results of the user to the search results of every other user on the system. In step 430 the match rate of the search to the chat rooms is calculated. In the present embodiment, matches of result links are more heavily weighted than matches of terms are. For example, without limitation, if a searched link coincides with any chat room link, the main matching rate increases 10 points, and if a term coincides with a chat room term, the main matching rate increases 1 point. Various point values may be used for matches in links and terms in alternate embodiments, and in some embodiments the values for link matches and term matches may be equal. In the present embodiment, after links and terms matching rates are calculated, it is determined if the search result is similar to a chat room or not in step 435. The system comprises a configurable coefficient of matching chat terms that is compared to the match rate calculated in step 430 to determine this. Once the system has detected a match, users are notified and given an option to enter the chat mode. Users will either enter an existing chat room or if a chat room does not exist for a given topic, a new chat room will be created. Typically, in the present embodiment users will be matched simply by matching keywords as the “Chat document” describes.

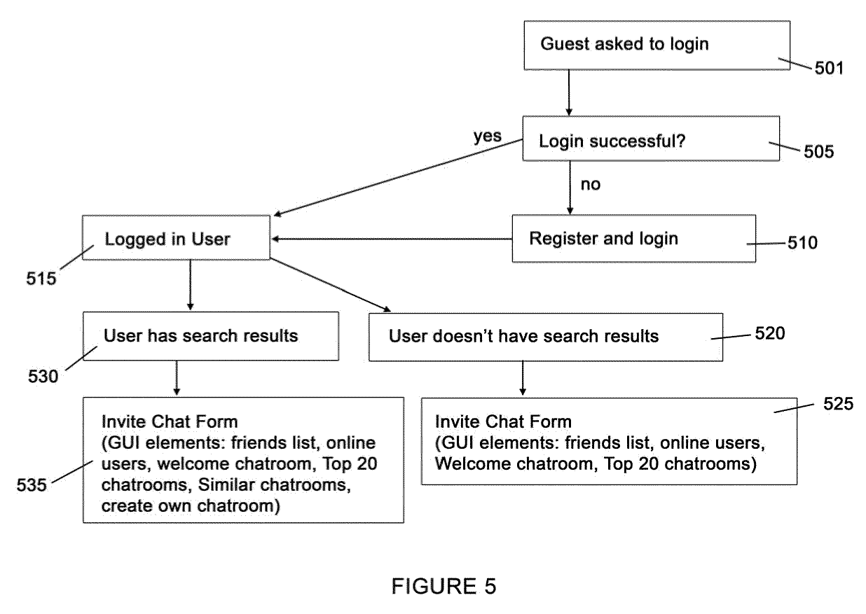

FIG. 5 is a flow chart illustrating an exemplary process for initiating a chat in an interactive and social search engine, in accordance with an embodiment of the present invention. The following process describes the user abilities and system behavior when a user selects a chat function in a social and interactive search engine, for example, without limitation, chat tab 105, shown by way of example in FIG. 1. In the present embodiment, there are two cases of chat functionality: a user is either a registered logged in user or the user is a guest. Guests do not have the ability to use the chat function. Alternate embodiments may enable guests to use the chat function. In the present embodiment, a current user that is a guest that is not logged in to the system is asked to login in step 501. The system determines if the login is successful in step 505. If the login is not successful, the user is asked to register with the system and then login in step 510. The present embodiment comprises a register button for users who do not have an account with the system and would like to be a registered user. A new user is logged in after filling out a registration form in step 510. After registration and login in step 510 or if login is successful in step 505, the user is now a registered, logged in user in step 515. In some embodiments of the present invention, users also have the option to login to the current system using third party social network login information, including but not limited to, Facebook™, MySpace™, Orkut™, Yahoo™, etc.

When the user attempts to join a chat session, there are two scenarios. In one scenario, the user has search results already, and in the other scenario, the user does not have search results. In order to have search results the user must have made at least one search. Different options are available to users who have search results and users who do not have search results. In step 520 the system has determined that the user does not have search results. In step 525, the graphic user interface (GUI) of the system displays an invite chat form that comprises elements for accessing a friends list, a list of currently online users, where the user may perform functions such as, but not limited to, adding someone to his friends list, a list of top recent searches, and a list of the top chat rooms, which are the chat rooms that have the most members. In step 530 the system has determined that the user has search results, and the GUI displays an invite chat form that comprises elements for accessing a friends list, a list of currently online users, a list of top searches, and a list of the top chat room in step 535, just as in step 525. However, in addition, since the user has search results, the system can also provide an additional GUI element in step 535, a list of similar chat rooms. In other embodiments of the present invention, the current system provides news headlines and articles from various sources, then the current system notifies users if one or more users are reading the same article. The user is then given the option to enter a chat room specific to an article giving users opportunity to chat, debate, vent, or discuss what he is reading with others in regard to the news article in real time. The vision and behavior of the GUI elements available in the invite chat forms in step 525 and 535 are further described below. Alternate embodiments may comprise various other GUI elements such as, but not limited to, a user profile element that enables the user to edit information in his profile including, without limitation, password and email address, a save element that enables the user to save search results, a favorites element that enables the user to mark websites as favorites, etc. Furthermore, some alternate embodiments may not include some of the GUI elements described in the foregoing such as, but not limited to, the top chat rooms list, the related chat rooms list, and top searches list, etc.

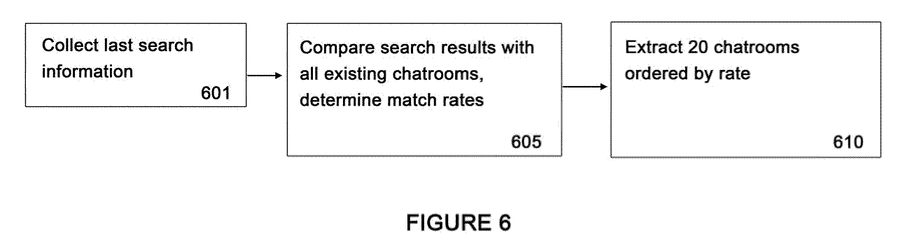

FIG. 6 is a flow chart illustrating an exemplary process for locating similar chat rooms for a similar chat room list from an interactive and social search engine, in accordance with an embodiment of the present invention. The similar chat rooms list is a list of chat rooms that have the same or similar discussion themes as the search performed by the user. In the present embodiment, the user may choose the similar chat room element from the GUI to see a list of chat rooms with the similar discussion themes and may join a discussion by clicking on any chat room from the similar chat room list. The chat rooms in similar chat room list have standard chat functionality. In the present embodiment, the similar chat rooms list is provided by a background SimilarChatRoomsProvider module. In order to compile the similar chat rooms list, the SimilarChatRoomsProvider module first collects the last set of search results for the user in step 601. Then in step 605, the module compares the search results with all existing chat rooms, calculates search result match rates for the existing chat rooms according a rate calculation scheme, for example, without limitation, the rate calculation scheme illustrated by way of example in FIG. 4, and sorts the chat rooms by match rate. The module then extracts a predetermined number of chat rooms with the best match rates, and presents these chat rooms to the user in the order of the match rates in step 610. In the present embodiment twenty similar chat rooms are returned to the user; however, more or fewer chat rooms may be returned to the user in alternate embodiments.

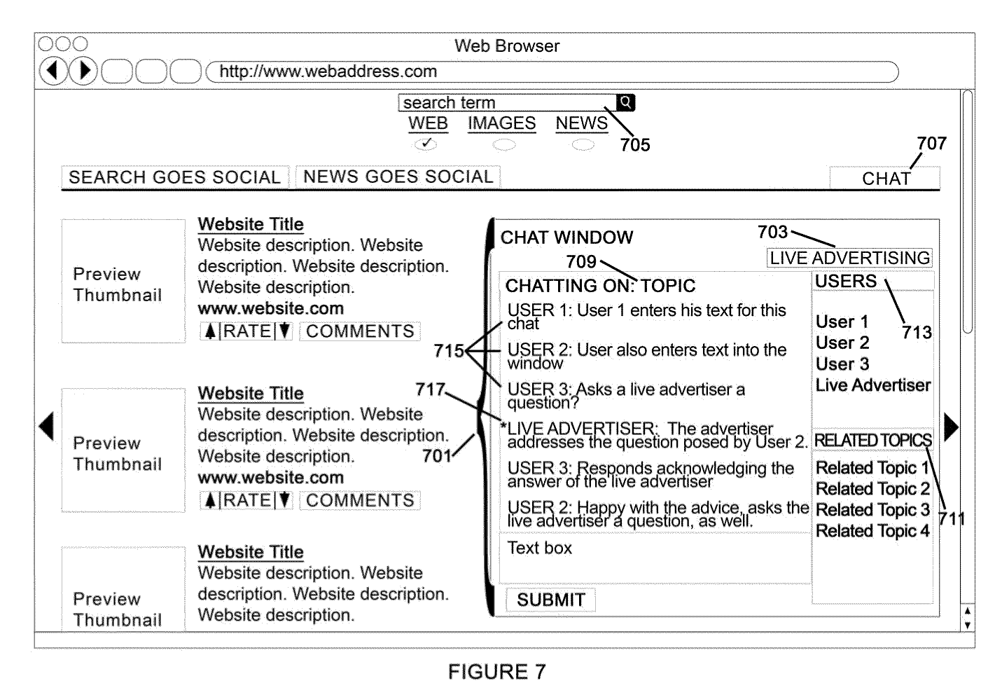

FIG. 7 illustrates an exemplary screenshot from a chat session in an interactive and social search engine, in accordance with an embodiment of the present invention. In the present embodiment, live “Real Time” people powered advertising sessions are embedded into the geographically specific chat session. A chat tab 707 is broken into two main sections, a topic based chat room 701 and an information based chat room 703. Topic based chat room 701 enables users to socialize with a defined topic. In topic based chat room 701 users can click any country and city and engage with people there. If visiting from a different geographic location, users can harness the power of moderators, or “travel consultants”, who are advertisers who can assist in either relocation or organizing a stay for example, without limitation, realtors or travel agents.

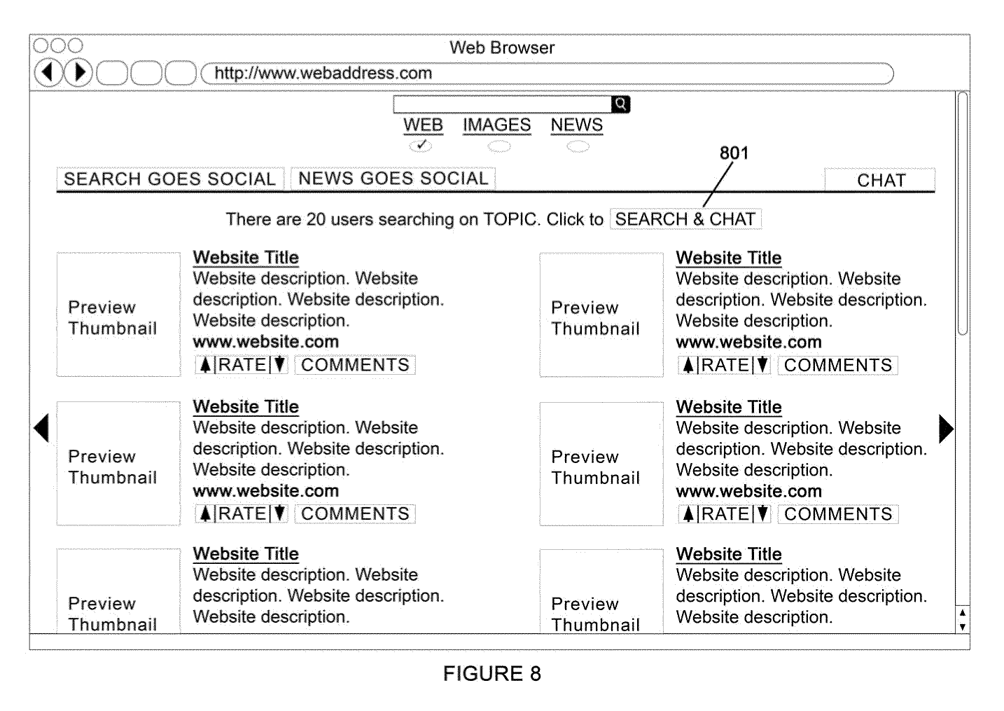

Referring to FIG. 7, a sample chat in topic based chat room 701 is shown. Topic based chat room 701 is a search based chat room that not only connects people searching for similar terms but also allows advertisers to engage in real time with potential consumers in an information based chat room 703. In the present embodiment, users can opt out of receiving advertising at any point. In order to connect to a topic related chat room in the present embodiment a user first enters a search term in a search box 705. Then, in reference to FIG. 8, the user is notified 801 that other users, advertisers or moderators that most closely match his search terms are available for chat. Topic based chat room 701 displays various types of information to the user including, but not limited to, a current room name 709, a related topic rooms list 711 and an online users list 713. Current room name 709 is the same as the searched term. If desired, the user may choose to enter one of the related chat rooms in related topic rooms list 711. A list of messages 715 is also displayed in topic based chat rooms 701 and information based chat rooms 703. In the present embodiment, a user may view both public and private messages, or the user may choose to view only public or only private massages. Some embodiments may also comprise a “live translator” that works in the background to enable users who speak different languages to chat with one another. For example, without limitation, a user who speaks Chinese would be able to communicate with another user searching the same topic in English using the live translator, although the Chinese user is typing in Chinese.

By providing a live advertising platform, the present embodiment matches people with the products and services for which they are searching. Advertisers are able to log on through the backend of the system to a management section in the search engine and choose a topic based chat room that suits their products or services in which to provide “live help” to users. An advertiser icon 717 indicates the status of the advertiser as an advertiser to other users and also indicates the company name and web address of the company that the advertiser is representing. In the present non-limiting example, the advertiser is participating in a public chat; however, users may also engage in a private discussion with any of the moderators or advertisers. As well, alternate embodiments of the present invention may expand this live advertising platform, without limitation, to mobile applications and SMS text messaging services.

FIG. 8 illustrates an exemplary screenshot of a notification system, in accordance with an embodiment of the present invention. When a user enters a search, if other users, are concurrently searching the same or similar topics, based on each user's topic relevancy settings, a notification 801 will appear on the screen informing users that, if desired, they may enter the search and chat mode. Alternatively or concurrently, the same notification 801 may appear if moderators, advertisers, or other information sources are available to engage with users at that same time. When a user clicks on the search and chat notification 801, a chat session related to the topic being searched opens, similar to the screenshot shown in FIG. 7.

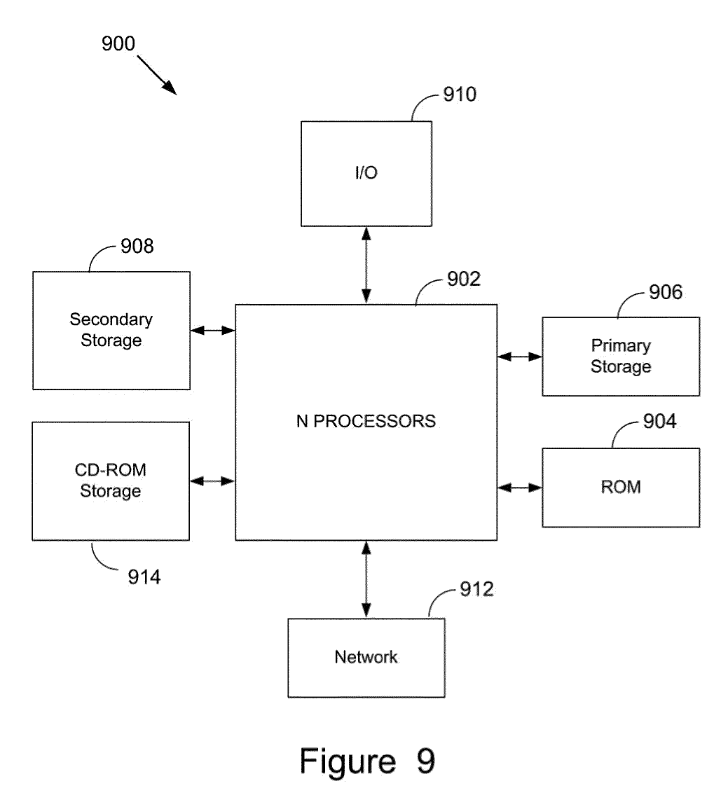

FIG. 9 illustrates a typical computer system that, when appropriately configured or designed, can serve as a computer system in which the invention may be embodied. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner. Both of these primary storage devices may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU. CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection as shown generally at 912, which may be implemented as a hardwired or wireless communications link using suitable conventional technologies. With such a connection, it is contemplated that the CPU might receive information from the network, or might output information to the network in the course of performing the method steps described in the teachings of the present invention.

The embodiments described in the foregoing were directed to embodiments implemented on the Internet. However, in alternate embodiments, interactive and social search engines may be implemented on other types of networks or data storage entities such as, but not limited to, local area networks (LANs), databases, etc. For example, without limitation, an interactive and social search engine may be implemented on a LAN at a library enabling patrons to search for books, published academic articles, or other items while taking advantage of the comments and ratings of these items left by other patrons and being able to chat with other patrons about their searches. In another non-limiting example, an interactive or social search engine may be implemented on a LAN at a university enabling students to search for and discuss topics such as, but not limited to, courses offered by the university or extracurricular activities.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC § 112 (6) it is intended that the corresponding means for and/or steps for carrying out the claimed function also include those embodiments, and equivalents, as contemplated above that implement at least some novel aspects and objects of the present invention in the jurisdiction of the USA. For example, some method steps or system modules may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing an interactive and social search engine according to the present invention will be apparent to those skilled in the art. The invention has been described above by way of illustration, and the specific embodiments disclosed are not intended to limit the invention to the particular forms disclosed. For example, the particular implementation of the graphic user interface (GUI) may vary depending upon the particular type of functions and options available. The GUIs described in the foregoing were directed to implementations with tabs and buttons; however, similar techniques are to provide GUIs with pop-up menus, scrolling lists, etc. Implementations of the present invention comprising variously configured GUIs are contemplated as within the scope of the present invention. The invention is thus to cover all modifications, equivalents, and alternatives falling within the spirit and scope of the following claims.

What is claimed is:

1. A system for an interactive and social search engine, the system comprising:
a search component responding to a user's search request for generating a listing of search results comprising site addresses;
a display component for displaying said listing along with a rating control for each site address in said listing; and
a rating component for accepting inputs from said rating control to affect an order of said listing where a change in a rating of a site address dynamically controls said displaying of said listing and subsequent search requests.

2. The system as recited in claim 0, further comprising a browsing control component for scrolling through and viewing content of each site address in said listing.

3. The system as recited in claim 0, further comprising a chat component for conducting organized communication sessions between users of the system where said sessions are organized by search topics.

4. The system as recited in claim 0, further comprising a communication component for communication between users of the system in real-time.

5. The system as recited in claim 0, further comprising a detection component for detecting concurrent users of the system requesting substantially similar searches and for establishing communication between said concurrent users.

6. The system as recited in claim 0, wherein said display component displays said listing as a plurality of pages with site addresses in said listing grouped by type of content into a plurality of groupings where said plurality of pages can be scrolled for viewing and each of said plurality of groupings can be scrolled independently of said plurality of pages.

7. A system for an interactive and social search engine, the system comprising:
means for generating a listing of search results;
means for displaying said listing along with a rating control; and
means for accepting inputs from said rating control to affect an order of said listing.

8. The system as recited in claim 7, further comprising means for scrolling through and viewing content of sites in said listing.

9. The system as recited in claim 7, further comprising means for conducting organized communication sessions between users of the system.

10. The system as recited in claim 7, further comprising means for communication between users of the system in real-time.

11. The system as recited in claim 7, further comprising means for detecting concurrent users of the system requesting substantially similar searches and for establishing communication between said concurrent users.

12. A method for an interactive and social search engine, the method comprising the steps of:
receiving a listing of search results corresponding to a user's search request;
displaying said listing along with a rating control for each site address in said listing; and
accepting inputs from said rating control to affect an order of said listing where a change in a rating of a site address dynamically controls said displaying of said listing and subsequent search requests.

13. The method as recited in claim 12, further comprising the step of scrolling through and viewing content of each site address in said listing.

14. The method as recited in claim 12, further comprising the step of conducting organized communication sessions between users of the system where said sessions are organized by search topics.

15. The method as recited in claim 12, further comprising the step of communication between users of the system in real-time.

16. The method as recited in claim 12, further comprising the step of detecting concurrent users of the system requesting substantially similar searches and for establishing communication between said concurrent users.

17. The method as recited in claim 12, wherein said step of displaying displays said listing as a plurality of pages with site addresses in said listing grouped by type of content into a plurality of groupings where said plurality of pages can be scrolled for viewing and each of said plurality of groupings can be scrolled independently of said plurality of pages.

18. A method for an interactive and social search engine, the method comprising:
steps for receiving a listing of search results corresponding to a user's search request;
steps for displaying said listing along with a rating control; and
steps for accepting inputs from said rating control to affect an order of said listing.

19. The method as recited in claim 18, further comprising steps for scrolling through and viewing content of sites in said listing.

20. The method as recited in claim 18, further comprising steps for conducting organized communication sessions between users of the system.

21. The method as recited in claim 18, further comprising steps for communication between users of the system in real-time.

22. The method as recited in claim 18, further comprising steps for detecting concurrent users of the system requesting substantially similar searches and for establishing communication between said concurrent users.
